(19) United States
(12) Patent Application Publication
(10) Pub. No.: US 2014/0108275 A1
(43) Pub. Date: Apr. 17, 2014

(54) PROPERTY MANAGEMENT SYSTEM

(71) Applicant: MOORCRAG LIMITED, London (GB)

(72) Inventor: Robert Heptonstall, Knaresborough (GB)

(73) Assignee: MOORCRAG LIMITED, London (GB)

(21) Appl. No.: 13/866,921

(22) Filed: Apr. 19, 2013

(30) Foreign Application Priority Data
Oct. 16, 2012 (GB) 1218512.0

(51) Int. Cl. G06Q 50/16; G06Q 30/00

(52) U.S. Cl. CPC G06Q 50/163; G06Q 30/01
USPC 705/314

(57) ABSTRACT

A property management system comprising computer readable location identifiers being associated with a respective location of property, and a server arranged to: receive data indicating a location of the property, the data indicating a location being generated by a computer associated with customers of the property based upon the location identifier; generate a request for further information from the customers based upon the property location data; transmit the request for further data to said computer; receive further information from said computer in response to said request for further data, the further information being provided by the customers; generate output data associated with management of the location of the property based upon said location identifier and said further information; and provide output data to the property manager to allow the property manager to perform management of the location based upon the further information provided by the customers.

### CROSS REFERENCE STATEMENT

This application claims the benefit of co-pending United Kingdom Patent Application No. 1218512.0, filed on Oct. 16, 2012, the entirety of which is incorporated herein by reference.

### TECHNICAL FIELD

The present invention relates to methods and apparatus for managing property.

### BACKGROUND OF THE INVENTION

It is desirable that properties are managed quickly and effectively. For example, often users of the property are paying for the use of the property, or for services managed within the property, and expect the building to be well maintained and fault free.

One way to ensure that faults within a property are quickly identified is for individuals to be employed to regularly check the property for faults. However employing an individual to check the property incurs costs and in any case does not ensure that faults are identified quickly as a property may be very large, and may for example consist of a number of associated buildings, such that a complete check of the property may take considerable time and a fault may not be identified quickly. Employing an individual to regularly check the property additionally typically requires more individuals to properly maintain the building.

One way in which faults in a property can be identified quickly is by users of the property notifying the property manager of any faults they discover. However users often do not report faults they are aware of for reasons such as not knowing how to report an identified fault. Even when a user has the details of who to contact to report a fault the information provided by the user is often limited and does not provide the necessary information to effectively rectify the fault.

Similarly, provision of services to users of a building requires that the services are provided to the users quickly and effectively. There is therefore a need for improvements in systems and methods for managing properties.

It is an object of the invention to provide improvements in property management.

### SUMMARY OF THE INVENTION

According to the invention there is provided a property management system for providing maintenance of a property used by a plurality of customers of the property, the property being managed by a property manager, the system comprising: a plurality of computer readable location identifiers, each location identifier being associated with a respective location of the property to be managed; a server arranged to: receive data indicating a location of the at least one property to be managed, the data indicating a location being generated by a computer associated with one of the plurality of customers of the property based upon the computer readable location identifier; generate a request for further information from the one of the plurality of customers of the property based upon the data indicating a location of the at least one property; transmit the request for further data to said computer associated with the one of the plurality of customers of the property; receive further information from the computer associated with the one of the plurality of customers of the property in response to the request for further information, the further information being provided by the one of the plurality of customers of the property; generate output data associated with management of the location of the at least one property to be managed based upon said location identifier and said further information; and provide the output data associated with management of the location of the at least one property to a computer associated with the property manager to allow the at least one property manager to perform management of the location based upon the further information provided by the one of the plurality of customers.

In this way, detailed and accurate information is collected from a user with no knowledge of the property required, and the collected information can be provided directly to a property manager responsible for managing the property. Because the server can identify the location of the property the server is able to request specific information associated with the location from the user and the server is therefore provided with improved information that enables the property to be quickly and effectively managed. The invention therefore provides advantages over prior art property management as it allows users of the property to assist with management of the property. Such user assistance with management of the property can reduce or eliminate the need for routine property checks by a property manager, as typically required in the prior art.

The customers of the building may for example be any user of the building that is different to the property manager. For example the customers may be employees of a company that uses the building, visitors to the building or individuals that are paying for a service within the building.

The maintenance of the property may be maintenance of assets located in the property, maintenance of the structure of the property or any other aspect of the property that may develop a fault and may require maintenance.

At least one of the plurality of computer readable location identifiers may comprise an optical machine-readable representation and the data indicating a location may be generated based upon an image of the computer readable location identifier captured by the computer.

At least one of the plurality of computer readable location identifiers may comprise a radio-frequency identification (RFID) tag.

The computer may be a mobile computing device such as a telephone or a tablet computer associated with a user of the property arranged to obtain the data indicating a location from at least one of the plurality of computer readable location identifiers using hardware of the mobile computing device, for example a camera of the mobile computing device or an RFID tag reader.

At least one of the plurality of computer readable location identifiers may comprise data associated with a respective computer associated with the location and the data indicating a location may be generated by the respective computer. For example, each of the plurality of locations may have a respective computer located at the location and the computer may include hardware that can be used to uniquely identify the computer and therefore the location.

The server may for example store data associating locations with identifiers such that upon receipt of the data identifying a location the server may perform a look-up based upon the data identifying the location to identify the particular location.

The request for further information may cause a user interface suitable for inputting data associated with the indicated location to be generated on the computer. For example, the computer may be provided with an application associated with property management that processes the request for further information and provides a user interface that is suitable for receiving the requested further information.

The output data may comprise an electronic message to a service provider of the property. For example the electronic message may be an email or a short message service (SMS) message or any other suitable electronic message. The server may be further arranged to transmit the electronic message to the service provider of the property.

The request for further data may comprise a request for information associated with a problem at the indicated location. For example the location may include a plurality of items of furniture/equipment and the request for information may provide a user interface that allows a user to select an item of furniture/equipment that has a fault that needs attention. Alternatively or additionally the request for information may request that an image of the item of furniture/equipment or a portion of the item of furniture/equipment is provided. For example the user interface may be an image capture interface.

Generating the request for further data based upon the data indicating a location of the at least one property may comprise selecting data from a database based upon said indicated location, wherein said request for further data is based upon said selected data. That is, the request for further data may be based upon a database look-up to determine data specific to the location.

The computer associated with the at least one property manager may for example be a portable computer such as a mobile telephone or a tablet computer. In this way the property manager can be provided with indications of problems with the property directly, removing the need for the property manager to actively check the property.

According to a second aspect of the invention there is provided a management system for managing delivery of services to rooms of a property used by a plurality of customers of the property, the property being managed by at least one property manager, the system comprising: a plurality of computer readable location identifiers, each location identifier being associated with a respective location of the property to be managed, and a server. The server is arranged to: receive data indicating a location of the at least one property to be managed, the data indicating a location being generated by a computer associated with one of the plurality of customers of the property based upon the computer readable location identifier; generate a request for further information from the one of the plurality of customers of the property based upon the data indicating a location of the at least one property; transmit the request for further data to said computer associated with the one of the plurality of customers of the property; receive further information from said computer in response to said request for further data, the further information being provided by the one of the plurality of customers of the property; generate output data associated with management of the location of the at least one property to be managed based upon said location identifier and said further information; and provide the output data associated with management of the location of the at least one property to a computer associated with the at least one property manager to allow the at least one property manager to manage delivery of services to the location based upon the further information provided by the one of the plurality of customers.

The second aspect of the invention therefore is similar to the first aspect of the invention, but rather than providing maintenance of the property the property manager manages needs of users of the property by providing services to locations of the property upon request from users of the property.

According to a further aspect of the invention there is provided a computer apparatus for use in a property management system for managing a property used by a plurality of customers of the property, the property being managed by at least one property manager, the apparatus being associated with one of the plurality of customers of the property, the apparatus comprising a memory storing processor readable instructions; and a processor arranged to read and execute instructions stored in the memory; wherein the processor readable instructions comprise instructions arranged to control the computer to: obtain data indicating a location from a computer readable location identifier of a plurality of computer readable location identifiers, each location identifier being associated with a respective location of at least one property to be managed; transmit the data indicating a location of the at least one property to be managed to a server; receive a request for further information, the request for further data being generated by a server based upon the data indicating a location of the at least one property; and transmit further information provided by the one of the plurality of customers of the property associated with the apparatus in response to said request for further data; wherein the location identifier and the further data provide data for generation of output data for the at least one property manager associated with management of the location of the at least one property to be managed, the output data allowing the at least one property manager to perform management of the location based upon the further data provided by the one of the plurality of customers.

The invention therefore also provides a computer apparatus arranged to allow a user to use the property management system.

The computer apparatus may be used in either of the systems described above. In particular, the management of the property may be maintenance of the property or may be service provision of the property.

The invention also provides a method of providing maintenance of a property used by a plurality of customers of the property, the property being managed by at least one property manager, the method comprising: providing a plurality of computer readable location identifiers, each location identifier being associated with a respective location of at least one property to be managed; obtaining, at a computer associated with one of the plurality of customers of the property, data indicating a location from one of said computer readable location identifiers; transmitting, by said computer to a server, said data indicating a location of the at least one property to be managed; generating, by said server, a request for further information from the one of the plurality of customers of the property based upon the data indicating a location of the at least one property; transmitting, from said server to said computer, the request for further information from the one of the plurality of customers of the property; receiving, at said computer from said server, a request for further information associated with the location; transmitting, from said computer to said server, further information associated with the location in response to the request for further data; receiving, at said server from said computer, the further information associated with the location; generating, at said server, output data associated with maintenance of the location of the at least one property to be managed based upon the location identifier and the further data; and providing the output data associated with maintenance of the location of the property to the property manager to allow the property manager to perform management of the location based upon the further information provided by the one of the plurality of customers.

It will be appreciated that the systems, methods and apparatus described above may be used to manage more than one property and/or the property may be managed by more than one property manager. Where the property is managed by more than one property manager each property manager may have an associated computer or alternatively the property managers may use a single computer associated with the property managers.

Aspects of the invention can be combined and it will be readily appreciated that features described in the context of one aspect of the invention can be combined with or used in other aspects of the invention.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

### BRIEF DESCRIPTION OF THE DRAWINGS

Embodiments of the invention will now be described, by way of example, with reference to the accompanying drawings in which:

FIG. 1 is a schematic illustration of a property management system according to the invention;

FIG. 1A is a schematic illustration of a computer suitable for carrying out the invention; and

FIG. 2 is a flow chart schematically showing transfer of data between computers in the network of FIG. 1.

### DETAILED DESCRIPTION

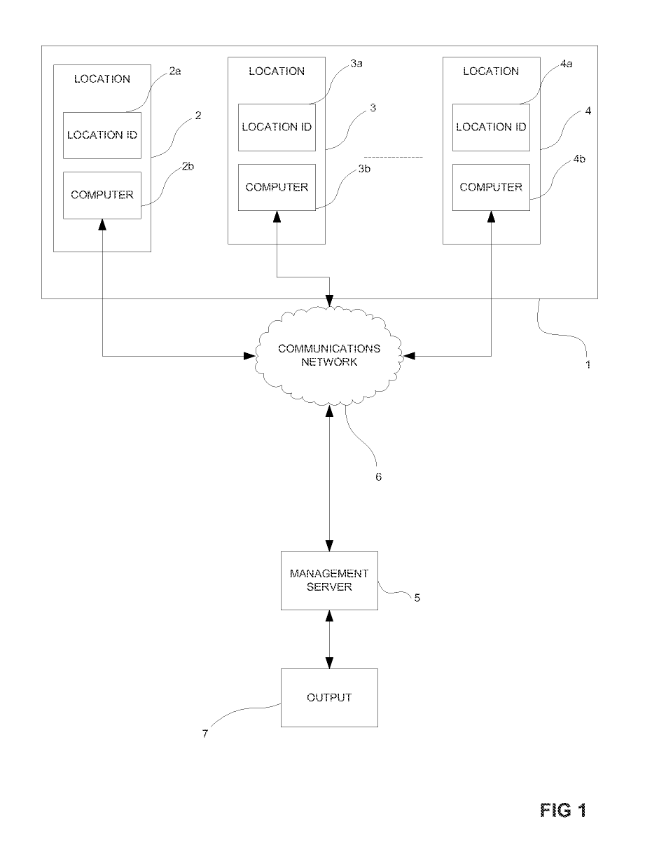

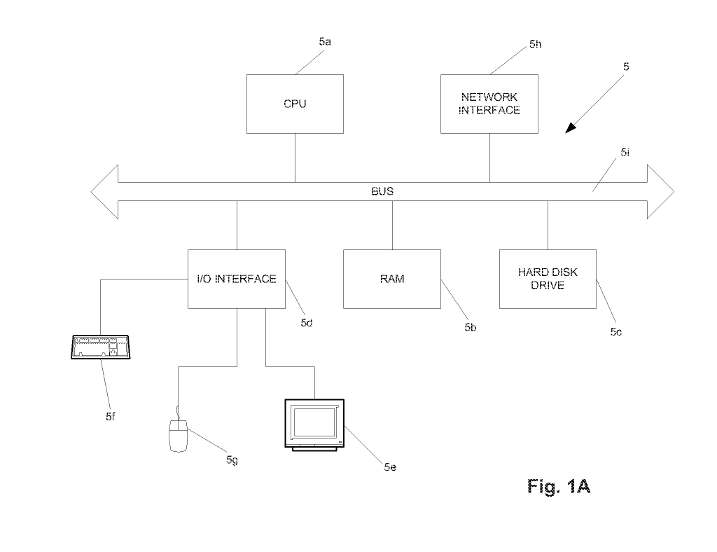

Referring first to FIG. 1, a property management system for management of at least one property 1 comprising a plurality of locations 2, 3, 4 is shown. The at least one property is used by a plurality of customers of the property and is managed by at least one property manager. The at least one property may be for example one or more buildings containing a plurality of serviced offices and the locations may be areas of the one or more buildings including the serviced offices and communal areas at which a problem may be identified by a customer. Alternatively the locations may be associated with particular items within an area such as items of machinery and/or furniture. The property therefore has at least two distinct groups of users, one group being a group of customers that use the facilities of the property and another group of users, which group may be a single property manager, that manages the property.

Each of locations 2, 3, 4 has a respective associated location identifier 2a, 3a, 4a that can be read by a computer 2b, 3b, 4b and processed by the computer 2b, 3b, 4b to generate data identifying the location associated with the location identifier. The location identifier 2a, 3a, 4a may be processed for example by an application running on the computer 2b, 3b, 4b. For example, each location identifier 2a, 3a, 4a may take the form of a bar code and computer 2b, 3b, 4b may be a portable computer such as a mobile telephone of a user of the location such that the bar code can be captured by a camera of the mobile telephone and processed to generate data identifying the associated location. It will be appreciated that more than one location may be used by a single user such that computers 2b, 3b, 4b may be a single portable computer such as a mobile telephone or tablet computer.

Alternatively each of location identifier 2a, 3a, 4a may have a corresponding computer 2b, 3b, 4b located at the respective location that may be used at the location to carry out the invention. Each location identifier may for example be data associated with the corresponding computer such as data associated with a network device of the computer such an IP address or a MAC address or the like. Alternatively the location identifier may be data embedded in software running on the computer that can be interpreted to uniquely identify the location associated with the computer. The location identifiers therefore allow the customers of the property to identify a location of the property whether or not they are familiar with the property. That is, the customers of the property may not use the property regularly, or may be using the property for the first time such that they may not be able to identify a location of the property to the property manager. However the location identifiers allow a location of the property to be easily identified to a property manager by a customer.

A management server 5 is arranged to communicate with computers 2b, 3b, 4b over a communications network 6. The data identifying the location that is generated based upon the location identifiers 2a, 3a, 4a can therefore be provided from the associated location by computers 2b, 3b, 4b to the management server 5 such that the management server 5 can automatically identify the location of a user of the property management system, for example where the user identifies a problem with the location. The management server 5 is arranged to generate a request for additional information based upon the data identifying the location and, using the communications network 6, to transmit the request for additional information to the computer 2b, 3b, 4b associated with the user. The computer 2b, 3b, 4b is arranged to process the request for additional information, for example using an application running on the computer that processed the location identifier, and to provide a user interface to the user that allows the user to input additional information as indicated in the request for additional information. The request for additional information may for example request an indication of the nature of a problem with the location.

The computer 2b, 3b, 4b communicates the requested additional information to the management server 5 using the communication network 6 and the management server 5 is arranged to process the data identifying the location and the additional information to generate an output 7. The output 7 is provided to the property manager to arrange for the problem to be fixed.

The invention therefore provides a property management system in which users of the property are able to provide detailed information that clearly identifies an associated location to a property manager that is responsible for managing the problem without requiring that the user of the property has any knowledge of the property. The central management server provides processing of various data to facilitate the interaction between the users and the property manager.

FIG. 1A shows the management server 5 in further detail, although it will be appreciated that each of computers 2b, 3b, 4b will typically have the same general structure. It can be seen that the server comprises a CPU 5a which is configured to read and execute instructions stored in a volatile memory 5b which takes the form of a random access memory. The volatile memory 5b stores instructions for execution by the CPU 5a and data used by those instructions. For example, in use, data such as data received from one of computers 2b, 3b, 4b may be stored in volatile memory 5b. The server 5 further comprises non-volatile storage in the form of a hard disc drive 5c. Data such as data received from computers 2b, 3b, 4b may be stored on hard disc drive 5c and may for example be analysed to generate data indicating common problems that arise in the property. The server 5 further comprises an I/O interface 5d to which are connected peripheral devices used in connection with the server 5. More particularly, a display 5e is configured so as to display output from the computer 5 such as output 7. Input devices are also connected to the I/O interface 5d. Such input devices may include a keyboard 5f and a mouse 5g which allow user interaction with the server 5. It will be appreciated that the computer may have other input interfaces, for example portable computers 2b, 3b, 4b may have any known portable computer interface such as a touch screen. A network interface 5h allows the server 5 to be connected to an appropriate communications network such as communications network 6 so as to receive and transmit data from and to other computers such as computers 2b, 3b, 4b. The CPU 5a, volatile memory 5b, hard disc drive 5c, I/O interface 5d, and network interface 5h, are connected together by a bus 5i.

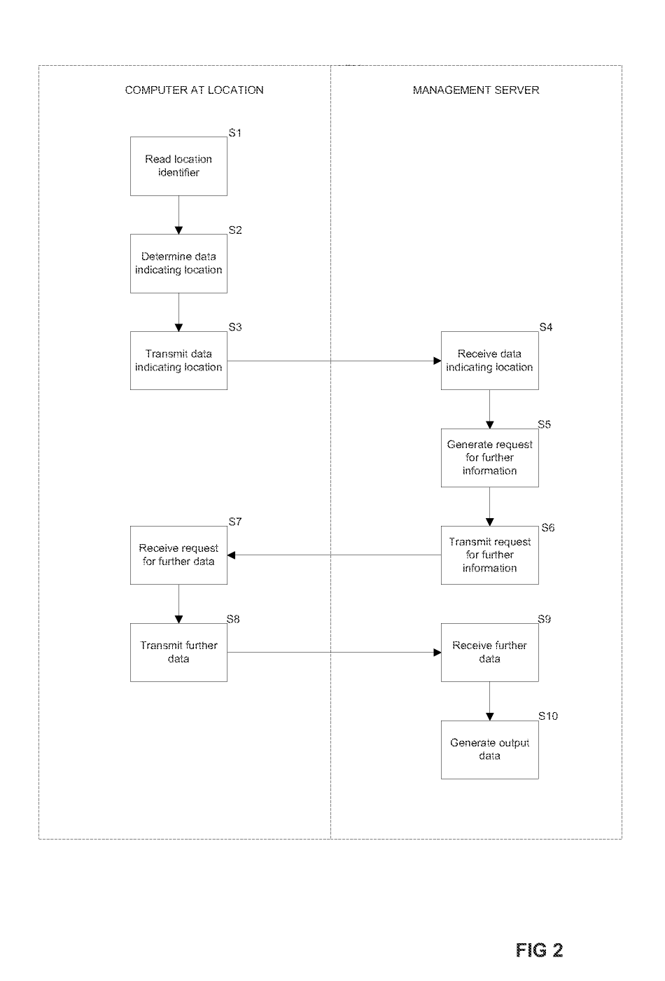

FIG. 2 shows processing carried out at a computer located at one of locations 2, 3, 4 and at management server 5, as shown in FIG. 1, to generate output data associated with a problem at the location. At step S1a location identifier at the location is read by the computer, for example by scanning a bar code at the location. Each location identifier 2a, 3a, 4a of FIG. 1 is arranged to provide data indicating its associated location to a computer 2b, 3b, 4b and may take any convenient form. For example, each computer 2b, 3b, 4b may be a portable computer such as a mobile telephone or other portable computing device such as a tablet computer associated with a user of the property management system and the location identifiers 2a, 3a, 4a may be machine readable codes such as a bar code or RFID tag that can be read by the mobile telephone. For example, each user of the property may be provided with software that can be run on a portable computer associated with the user when they first use the property such that each user of the property is able to use the property management system whenever required, for example whenever a fault with the property is identified by the user.

At step S2 data indicating the location is determined based upon the machine readable code and at step S3 the data indicating the location is transmitted to the management server. For example, where the machine readable code is a bar code, an application running on the computer may process the bar code to determine data indicating the location that the management server can use to identify the particular location of the plurality of locations 2, 3, 4 of the property.

At step S4 the data indicating the location is received by the management server 5 and at step S5 the management server processes the data indicating the location to generate a request for further information from the user. For example the management server 5 may perform a database look-up based upon the data indicating the location to determine the associated location and determine further information that is required for the indicated location.

For example, the request for further information may include a request for an indication of the nature of the fault identified by the user. The request for further information is generally based upon the identified location and where the location is an area of the property may take the form of a request for an indication of equipment known to be located at the location that may have a fault. Alternatively, where the location identifies a particular item within an area such as items of machinery and/or furniture, the request for further information may include a request for details of the nature of the fault with a particular item within an area such as items of machinery and/or furniture. It will be appreciated that where the location is an area of the property and a request for identification includes a request for an indication of particular equipment at the location that has a fault, the request for further information may additionally include a request for details of the nature of the fault. Alternatively or additionally the request for further information may provide instructions for the user to try to rectify the fault and to provide feedback to the system in connection with carrying out the instructions to try to rectify the fault.

At step S6 the request for further information is transmitted to the computer associated with the user at the location and at step S7 the request for further information is received by the computer at the location and the user is provided with a user interface to allow the user to input the requested further information. For example, the request for further information may be processed by an application of the computer and a user interface may be generated based upon the particular information that is requested. The user interface may take any convenient form and may include drop down lists and user selectable options. At step S8 further information input to the computer by the user is transmitted to the management server and at step S9 the further data input by the user is received by the management server.

At step S10 the management server processes the data identifying the location and the received further information to generate output data. The output data is provided to the at least one property manager. For example, the output data may be provided to a computer associated with the at least one property manager that is different to the computer associated with the user. Because the data identifying the location and the received further information is generated based upon reading a location identifier located at the particular location the output data is based upon reliable information. Accordingly the output data may be used by the property manager to attend to a fault identified by the data provided by the user and the request for further information, with the property manager having sufficient information to attend to the matter identified by the user. For example, the output may take the form of an email or other electronic communication that is sent directly to a portable computer associated with the property manager and the property manager may for example organise for a service provider to respond to the identified matter. Alternatively the property may be managed by a plurality of property managers, each property manager managing a particular aspect of the property, and the server may automatically provide output data to one of the property managers based upon a predetermined set of rules.

The server may additionally be arranged to provide update information to users of the property. For example, where a user reports a fault with the property, the server may provide an update to the user to indicate when the fault will be resolved and/or when the fault has been resolved. Alternatively or additionally the server may provide an update to all users of the property, or to a subset of users of the property that may be affected by the fault. The subset of users of the property may for example be determined based upon stored data associated with each of the users of the property and the location associated with the fault, for example indicating which users of the property use particular areas of the property.

Whilst it is described above that the invention is used for providing an indication and details of a fault with a property, it will be appreciated that the invention has applications in other areas of property management. For example the invention may be used in hotel management whereby a location identifier may be provided in rooms of the hotel and the request for further data may for example provide a room service menu from which selections can be made. In such an embodiment the location identifier may indicate a hotel room or a spa treatment reservation menu and the location identifier may indicate a spa associated with the hotel. In such an embodiment the property manager may be an individual responsible for arranging room service or arranging treatments for customers and the information that is provided by the system of the invention allows the property manager to more effectively manage services in the building. It will be appreciated that various other requests for further data and corresponding provided further data than those described herein as would be contemplated by the skilled person fall within the scope of the invention. Where the system provides the provision of services to locations of the property the server may provide updates to the customer relating to the provision of requested services, for example indicating when services will be available at a location.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A property management system for providing maintenance of a property used by a plurality of customers of the property, the property being managed by a property manager, the system comprising:
a plurality of computer readable location identifiers, each location identifier being associated with a respective location of the property to be managed;
a server arranged to:
receive data indicating a location of the at least one property to be managed, the data indicating a location being generated by a computer associated with one of the plurality of customers of the property based upon the computer readable location identifier;
generate a request for further information from the one of the plurality of customers of the property based upon the data indicating a location of the at least one property;
transmit the request for further data to said computer associated with the one of the plurality of customers of the property;
receive further information from said computer in response to said request for further data, the further information being provided by the one of the plurality of customers of the property;
generate output data associated with maintenance of the location of the at least one property to be managed based upon said location identifier and said further information; and
provide the output data associated with maintenance of the location of the property to a computer associated with the property manager to allow the property manager to arrange maintenance of the location based upon the further information provided by the one of the plurality of customers.

2. A property management system according to claim 1, wherein at least one of the plurality of computer readable location identifiers is selected from the group consisting of: an optical machine-readable representation and wherein the data indicating a location is generated based upon an image of the computer readable location identifier captured by said computer; and a radio-frequency identification tag.

3. A property management system according to claim 1, wherein said computer is a mobile telephone or a tablet computer associated with a user of the property.

4. A property management system according to claim 1, wherein at least one of the plurality of computer readable location identifiers comprises data associated with a respective computer associated with the location and wherein said data indicating a location is generated by said respective computer.

5. A property management system according to claim 1, wherein the request for further information causes a user interface suitable for inputting data associated with the indicated location to be generated on said computer.

6. A property management system according to claim 1, wherein said output data comprises an electronic message to a service provider of the property.

7. A property management system according to claim 1, wherein the request for further data comprises a request for information associated with a problem at the indicated location.

8. A property management system according to claim 7, wherein the server is further arranged to transmit said electronic message to said service provider of the property.

9. A property management system according to claim 1, wherein generating the request for further data based upon the data indicating a location of the at least one property comprises:
selecting data from a database based upon said indicated location, wherein said request for further data is based upon said selected data.

10. A property management system for managing delivery of services to rooms of a property used by a plurality of customers of the property, the property being managed by a property manager, the system comprising:
a plurality of computer readable location identifiers, each location identifier being associated with a respective location of the property to be managed;
a server arranged to:
receive data indicating a location of the at least one property to be managed, the data indicating a location being generated by a computer associated with one of the plurality of customers of the property based upon the computer readable location identifier;
generate a request for further information from the one of the plurality of customers of the property based upon the data indicating a location of the at least one property;
transmit the request for further data to said computer associated with the one of the plurality of customers of the property;
receive further information from said computer in response to said request for further data, the further information being provided by the one of the plurality of customers of the property;
generate output data associated with delivery of services to the location of the at least one property based upon said location identifier and said further information; and
provide the output data associated with management of the location of the property to a computer associated with the property manager to allow the property manager to perform management of the location based upon the further information provided by the one of the plurality of customers.

11. A computer apparatus for use in a property management system for managing a property used by a plurality of customers of the property, the property being managed by a property manager, the apparatus being associated with one of the plurality of customers of the property, the apparatus comprising:
a memory storing processor readable instructions; and
a processor arranged to read and execute instructions stored in the memory;
wherein the processor readable instructions comprise instructions arranged to control the computer to:
obtain data indicating a location from a computer readable location identifier of a plurality of computer readable location identifiers, each location identifier being associated with a respective location of at least one property to be managed;
transmit said data indicating a location of the at least one property to be managed to a server;
receive a request for further information, the request for further information being generated by a server based upon the data indicating a location of the at least one property; and
transmit further information provided by the one of the plurality of customers of the property associated with the apparatus in response to said request for further data;
wherein said location identifier and said further data provide data for generation of output data for the property manager associated with management of the location of the at least one property to be managed, the output data allowing the property manager to perform management of the location based upon the further data provided by the one of the plurality of customers.

12. A computer apparatus according to claim 11, wherein the apparatus is for use in a property management system for providing maintenance in the property.

13. A computer apparatus according to claim 11, wherein the apparatus is for use in a property management system for delivery of services to rooms of the property.

14. A computer apparatus according to claim 11, wherein at least one of the plurality of computer readable location identifiers is selected from the group consisting of: an optical machine-readable representation and wherein the data indicating a location is generated based upon an image of the computer readable location identifier captured by said computer; and a radio-frequency identification tag.

15. A computer apparatus according to claim 11, wherein said computer apparatus is a mobile telephone or a tablet computer associated with a user of the property.

16. A computer apparatus according to claim 11, wherein the computer readable location identifier of the plurality of computer readable location identifiers comprises data associated with the computer apparatus and wherein said data indicating a location is generated by said computer apparatus.

17. A computer apparatus according to claim 11, wherein the received request for further information causes a user interface suitable for inputting data associated with the indicated location to be generated on the computer apparatus.

18. A computer apparatus according to claim 11, wherein the request for further data comprises a request for information associated with a problem at the indicated location and/or a request for provision of a service at the indicated location.

19. A method of providing maintenance of a property used by a plurality of customers of the property, the property being managed by a property manager, the method comprising:
providing a plurality of computer readable location identifiers, each location identifier being associated with a respective location of at least one property to be managed;
obtaining, at a computer, data indicating a location from one of said computer readable location identifiers, said data indicating a location being obtained by one of the plurality of customers of the property;
transmitting, by said computer to a server, said data indicating a location of the at least one property to be managed;
generating, by said server, a request for further information from the one of the plurality of customers of the property based upon the data indicating a location of the at least one property;
transmitting, from said server to said computer, the request for further information from the one of the plurality of customers of the property;
receiving, at said computer from said server, the request for further information from the one of the plurality of customers of the property;
transmitting, from said computer to said server, further information associated with the location in response to the request for further data;
receiving, at said server from said computer, the further information associated with the location;
generating, at said server, output data associated with maintenance of the location of the property to be managed based upon the location identifier and the further data; and
providing the output data associated with maintenance of the location of the property to a computer associated with the property manager to allow the property manager to perform management of the location based upon the further information provided by the one of the plurality of customers.

20. A method of managing delivery of services to rooms of a property used by a plurality of customers of the property, the property being managed by a property manager, the method comprising:
providing a plurality of computer readable location identifiers, each location identifier being associated with a respective location of at least one property to be managed;
obtaining, at a computer, data indicating a location from one of said computer readable location identifiers, said data indicating a location being obtained by one of the plurality of customers of the property;
transmitting, by said computer to a server, said data indicating a location of the at least one property to be managed;
generating, by said server, a request for further information from the one of the plurality of customers of the property based upon the data indicating a location of the at least one property;
transmitting, from said server to said computer, the request for further information from the one of the plurality of customers of the property;
receiving, at said computer from said server, the request for further information from the one of the plurality of customers of the property;
transmitting, from said computer to said server, further information associated with the location in response to the request for further data;
receiving, at said server from said computer, the further information associated with the location;
generating, at said server, output data associated with delivery of services to the location of the property to be managed based upon the location identifier and the further data; and
providing the output data associated with delivery of services to the location of the property to a computer associated with the property manager to allow the property manager to perform management of the location based upon the further information provided by the one of the plurality of customers.
